(19) United States
(12) Patent Application Publication
(10) Pub. No.: US 2018/0266993 A1
(43) Pub. Date: Sep. 20, 2018

(54) NON-DESTRUCTIVE EVALUATION OF ADDITIVE MANUFACTURING COMPONENTS

(71) Applicant: EDISON WELDING INSTITUTE, INC., Columbus, OH (US)

(72) Inventor: Evgueni I. TODOROV, Loveland, CO (US)

(21) Appl. No.: 15/984,899

(22) Filed: May 21, 2018

Related U.S. Application Data
(63) Continuation-in-part of application No. 14/971,469, filed on Dec. 16, 2015.
(60) Provisional application No. 62/096,300, filed on Dec. 23, 2014.
(60) Provisional application No. 62/509,816, filed on May 23, 2017.

(51) Int. Cl. G01N 27/90; B29C 64/393; B29C 64/153; B22F 3/105

(52) U.S. Cl. CPC G01N 27/9013; B29C 64/393; B33Y 50/02; B22F 3/1055; B29C 64/153

(57) ABSTRACT

A system for non-destructively evaluating components fabricated by additive manufacturing processes that includes a sensor array embedded within an electromagnetic field concentrating material or matrix, and that includes a plurality of individual elements arranged in a predetermined pattern for allowing substantially uniform coverage of an area of an electrically conductive component to be evaluated; wherein each element in the plurality of elements further includes at least one coil that acts as an exciter coil for generating an alternating electromagnetic field when activated, or a receiver coil for measuring a change in impedance of the at least one coil, or as both an exciter coil and a receiver coil; wherein the alternating electromagnetic field induces eddy currents in the component to be evaluated; and wherein the individual elements in the sensor array are excited in a predetermined sequence during a single pass of the sensor array over the area of a component to be evaluated.

### CROSS-REFERENCE TO RELATED APPLICATIONS

This patent application is a Continuation-In-Part of U.S. patent application Ser. No. 14/971,469 filed on Dec. 16, 2015 and entitled “Non-Destructive Evaluation of Additive Manufacturing Components Using Eddy Current Array System and Method”, which claimed the benefit of U.S. Provisional Patent Application Ser. No. 62/096,300 filed on Dec. 23, 2014 and entitled “Non-Destructive Evaluation of Additive Manufacturing Components Using Eddy Current Array System and Method”, the disclosures of which are hereby incorporated by reference herein in their entirety and made part of the present U.S. utility patent application for all purposes. This application also claims the benefit of U.S. Provisional Patent Application Ser. No. 62/509,816 filed on May 23, 2017 and entitled “Non-Destructive Evaluation of Additive Manufacturing Components Using Eddy Current Array System and Method”, the disclosure of which is hereby incorporated by reference herein in its entirety and made part of the present U.S. utility patent application for all purposes.

### STATEMENT REGARDING FEDERALLY-FUNDED RESEARCH

This invention was made with government support under U.S. Government Contract No. 70NANB14H273 awarded by the National Institute of Standards and Technology (NIST), United States Department of Commerce. The government has certain rights in the invention.

### BACKGROUND OF THE INVENTION

The present invention relates in general to non-destructive evaluation (NDE) techniques for use in manufacturing and more specifically to a non-destructive evaluation of components made by additive manufacturing processes using an array eddy current system and method. Additive Manufacturing (AM) refers to a process by which digital three-dimensional design data is used to build up a component from sequentially deposited layers of material. As opposed to milling a component from solid block of material, additive manufacturing builds up components layer by layer using materials which are available in fine powder or other forms (e.g. solid wire). A range of different metals, plastics and composite materials may be used for this purpose. The strengths of additive manufacturing often lie in those areas where conventional manufacturing has reached its limitations. Additive manufacturing allows for the fabrication of highly complex structures which can still be extremely light and stable. This process also provides a high degree of design freedom, the optimization and integration of functional features, the manufacture of small batch sizes at reasonable unit costs, and a high degree of product customization even in serial production. A powder based additive manufacturing process typically starts by applying a thin layer of the powdered material to a building platform. A powerful laser beam then fuses the powder at exactly the points defined by the computer-generated component design data. The platform is then lowered, and another layer of powder is applied. The material is again fused to bond with the layer below at the predefined points. Depending on the material used, components can be manufactured using stereolithography, laser sintering, laser melting, electron beam melting, direct energy deposition or other technologies commonly referred as 3D printing.

Various non-destructive evaluation techniques (e.g., visual, ultrasonics, liquid penetrant, magnetic particles, eddy current, radiography, or others as applicable) may be used as a single modality or in combination for examining critical additive manufacturing components after the fabrication thereof. However, post additive manufacturing examination may be very challenging, if even possible, for certain components having complex shapes, where the full benefits of the additive manufacturing process are realized. A possible approach to addressing this issue would be to conduct very comprehensive monitoring and examination of the additive manufacturing components during fabrication, ideally layer-by-layer. Various modalities have been proposed and used for monitoring additive manufacturing process parameters, component shape, heat transfer, and other relevant aspects and parameters. However, non-destructive evaluation techniques that will simultaneously detect small surface and subsurface, tight and volumetric discontinuities as well as large areas having irregular shapes exposed and/or hidden by powder have not been adequately demonstrated. Thus, there is an ongoing need for a fully effective system and/or method for conducting non-destructive evaluation of components created by the additive manufacturing process.

### SUMMARY OF THE INVENTION

The following provides a summary of certain exemplary embodiments of the present invention. This summary is not an extensive overview and is not intended to identify key or critical aspects or elements of the present invention or to delineate its scope. However, it is to be understood that the use of indefinite articles in the language used to describe and claim the present invention is not intended in any way to limit the described system. Rather the use of “a” or “an” should be interpreted to mean “at least one” or “one or more”.

In accordance with one aspect of the present invention, a first system for non-destructively evaluating components fabricated by additive manufacturing systems and processes for non-destructively evaluating components fabricated by additive manufacturing is provided. This system includes a sensor array that is embedded within an electromagnetic field concentrating material or matrix, wherein the sensor array includes a plurality of individual elements arranged in a predetermined pattern for allowing substantially uniform coverage of an area of an electrically conductive component to be evaluated; wherein each element in the plurality of elements further includes at least one coil that acts as an exciter coil for generating an alternating electromagnetic field when activated, or a receiver coil for measuring a change in impedance of the at least one coil, or as both an exciter coil and a receiver coil; wherein the alternating electromagnetic field induces eddy currents in the component to be evaluated; and wherein the individual elements in the sensor array are excited in a predetermined sequence during a single pass of the sensor array over the area to be evaluated.

In accordance with another aspect of the present invention, a second system for non-destructively evaluating components fabricated by additive manufacturing systems and processes for non-destructively evaluating components fabricated by additive manufacturing is provided. This system includes a sensor array embedded within an electromagnetic field concentrating material or matrix, wherein the sensor array includes a plurality of individual elements arranged in a predetermined pattern for allowing substantially uniform coverage of an area of an electrically conductive component to be evaluated; wherein each element in the plurality of elements further includes at least one coil that acts as an exciter coil for generating an alternating electromagnetic field when activated, or a receiver coil for measuring a change in impedance of the at least one coil, or as both an exciter coil and a receiver coil; wherein the alternating electromagnetic field induces eddy currents in the component to be evaluated; and wherein the individual elements in the sensor array are excited in a predetermined sequence during a single pass of the sensor array over the area to be evaluated; and a processor for receiving and characterizing data gathered by the sensor array, wherein the processor is configured to include a working channel and a reference channel, and wherein the working channel and reference channel cooperate to cancel out any background signal originating from the component being evaluated and the surrounding environment.

In accordance yet another aspect of the present invention, a third system for non-destructively evaluating components fabricated by additive manufacturing systems and processes for non-destructively evaluating components fabricated by additive manufacturing is provided. This system includes a sensor array embedded within an electromagnetic field concentrating material or matrix, wherein the sensor array includes a plurality of individual elements arranged in a staggered pattern for allowing substantially uniform coverage of an area of an electrically conductive component to be evaluated; wherein each element in the plurality of elements further includes at least one coil that acts as an exciter coil for generating an alternating electromagnetic field when activated, or a receiver coil for measuring a change in impedance of the at least one coil, or as both an exciter coil and a receiver coil; wherein the alternating electromagnetic field induces eddy currents in the component to be evaluated; and wherein the individual elements in the sensor array are excited in a predetermined sequence during a single pass of the sensor array over the area to be evaluated; a processor for receiving and characterizing data gathered by the sensor array, wherein the processor is configured to include a working channel and a reference channel, and wherein the working channel and reference channel cooperate to cancel any background signal originating from the component being evaluated and the surrounding environment; and a plurality of thermal sensors for gathering temperature information during an additive manufacturing process wherein the sensor array is evaluating a component being fabricated.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is a bottom view of an electromagnetic sensor array in accordance with an exemplary embodiment of the present invention illustrating the placement of the individual coils within the array;

FIG. 2 is a top view of an electromagnetic sensor array in accordance with an exemplary embodiment of the present invention illustrating the configuration of the connecting plate;

FIG. 3 is flowchart illustrating the components and functionality of an NDE system using an electromagnetic sensor array, in accordance with an exemplary embodiment of the present invention;

FIG. 4 is flowchart illustrating the components and functionality of the front-end electronics of an NDE system using the electromagnetic sensor array of the present invention;

FIG. 5 is an illustration of an exemplary embodiment of the system of the present invention being used to evaluate a laser-powder bed fusion (L-PBF) process;

FIG. 6 is an illustration of the test coupon used with the electromagnetic sensor array of the present invention, wherein a series of notches or grooves have been formed in the test coupon;

FIG. 7 is a graph showing signal magnitude at a notch depth of 160 μm at layer 29 (L29) and at a notch depth of 720 μm at layer 44 (L44) along the scan path of a single channel (channel 13) of the electromagnetic sensor array of the present invention;

FIG. 8 is a graph showing signal phase at a notch depth of 160 μm at layer 29 (L29) and at a notch depth of 720 μm at layer 44 (L44) along the scan path of a single channel (channel 13) of the electromagnetic sensor array of the present invention;

FIG. 9 is an illustration of the test coupon used with the electromagnetic sensor array of the present invention, wherein a large area of lack of fusion area (LOF) has been formed in the test coupon;

FIG. 10 is a graph showing signal magnitude across the LOF area formed in the test coupon of FIG. 9 along the scan path of channel 19 of the electromagnetic sensor array of the present invention;

FIG. 11 is a graph showing signal phase across the LOF area formed in the test coupon of FIG. 9 along the scan path of channel 19 of the electromagnetic sensor array of the present invention;

FIG. 12 a graph showing signal magnitude away from the LOF area foi rued in the test coupon of FIG. 9 along the scan path of channel 26 of the electromagnetic sensor array of the present invention; and

FIG. 13 is a graph showing signal phase away from the LOF area formed in the test coupon of FIG. 9 along the scan path of channel 26 of the electromagnetic sensor array of the present invention.

### DETAILED DESCRIPTION OF THE INVENTION

Exemplary embodiments of the present invention are now described with reference to the Figures. Although the following detailed description contains many specifics for purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

The present invention relates in general to non-destructive evaluation (NDE) techniques for use in manufacturing and more specifically to a NDE of components made by additive manufacturing (AM) processes using an array eddy current system and method. This invention may be used for both process monitoring and NDE during and after fabrication. The disclosed sensor and NDE method significantly reduce post additive manufacturing NDE requirements by examining the entire volume of each layer for critical surface and subsurface discontinuities and or conditions with any orientation. The method of the present invention permits fast repair and re-examination of any such repair while the part being built is still in the device chamber and without the removal of powder (thereby reducing waste).

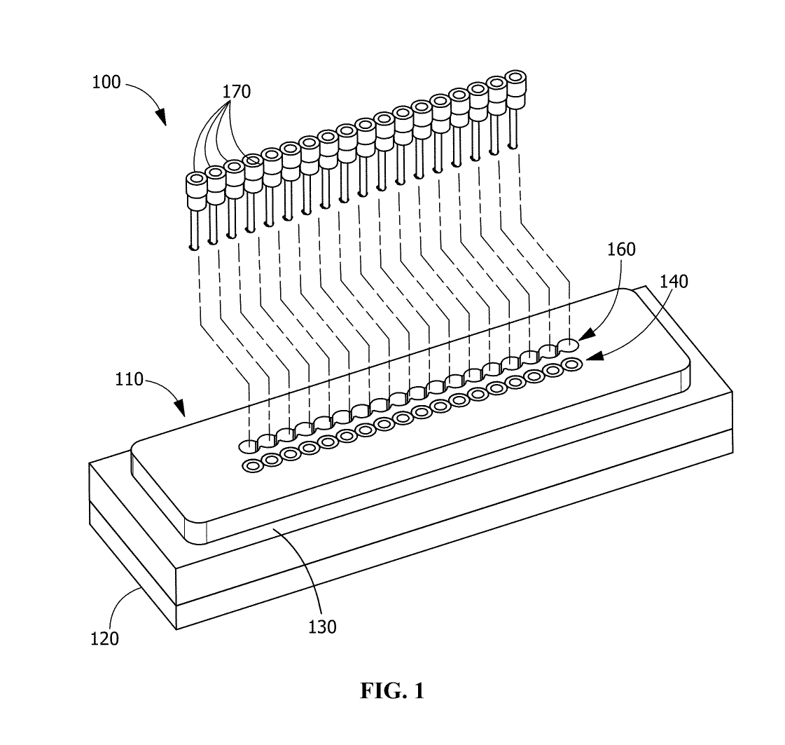

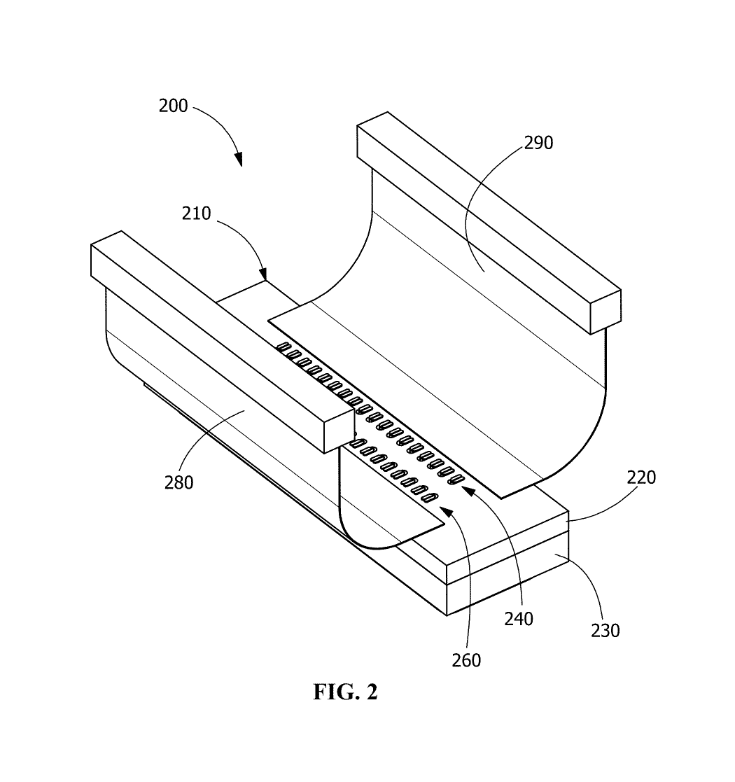

With reference to the Figures, the disclosed invention provides NDE systems, devices, and methods for assessing the quality components and parts created by additive manufacturing systems and processes. As shown in FIG. 1, electromagnetic sensor array 100 (which is shown in an inverted position) includes body 110, which further includes top portion 120 and bottom portion 130, which acts as a field concentrator. First row 140 of individual elements (or coils) 150 is arranged in a staggered, substantially parallel position relative to second row 160 of individual elements (or coils) 170. Staggering the rows of elements in this manner permits more uniform coverage of the inspected area on an AM component or part. In this embodiment, each row includes 18 individual elements or coils for a total of 36 coils in the array. Other configurations are possible. FIG. 2 is a top view of an electromagnetic sensor array 200, which further includes a body 210 having a top portion 220 (that includes a printed circuit board) and a bottom portion 230. A first row of connectors 240 is positioned in parallel to a second row of connectors 260 in top portion 220. First and second wire leads 280 and 290 are also attached to top portion 220 and are shown in a flexed configuration.

Array elements 150 and 170 are excited in a predetermined sequence while the entire array is scanned to cover the entire area of analysis in a single pass. When an individual coil is excited, an alternating magnetic field is generated that then induces eddy currents in the AM component or part, if the AM component or part is electrically conductive. The density and distribution of eddy currents in the AM component or part being evaluated is dependent on material electromagnetic properties (e.g., magnetic permeability and electrical conductivity), electromagnetic field strength and frequency, geometry of the AM component or part, and the geometry of the element or coil generating the field. Changes in the eddy current electromagnetic field caused by changes in additive manufacturing material properties that affect electrical conductivity and/or magnetic permeability, presence of discontinuities and variations of distance between the sensor and inspected area (e.g., surface irregularity) will be registered with the same or different elements or coils of electromagnetic sensor array 100/200 (also referred to herein as an array eddy current (AEC) sensor.

Elements other than coils, such as Hall-effect sensors and giant magnetoresistive (GMR) sensors, are used as receivers in alternate embodiments of this invention. For use in this invention, an electromagnetic field can be generated by a coil, or single or multiple conductors with a current to produce a field having maximum sensitivity for detecting discontinuities and conditions of interest in AM components or parts. The electromagnetic sensors of this invention also utilize magnetic field concentrating material for increasing sensitivity and resolution compared to conventional designs.

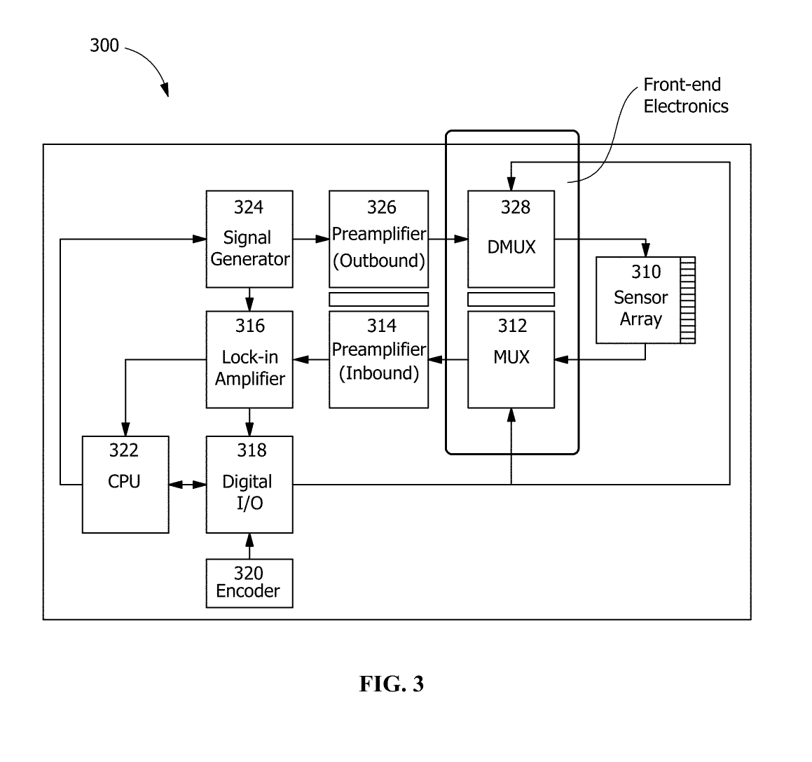

FIG. 3 is flowchart illustrating the components and functionality of NDE system 300 using the electromagnetic sensor array of the present invention. In general terms, an electromagnetic sensor array is connected to a demultiplexer (DMux) and a multiplexer (Mux) for receiving an electrical signal from a generator, creating an electromagnetic field, and transmitting a measured signal containing information from an evaluated AM component or part for signal processing. The exemplary system shown in FIG. 3 includes electromagnetic sensor array 310, Mux 312, inbound preamplifier 314, lock-in amplifier 316, digital I/O 318, encoder 320, CPU 322, signal generator 324, outbound preamplifier 326, and DMux 328. Other configurations of this system are possible and are also aspects of the present invention.

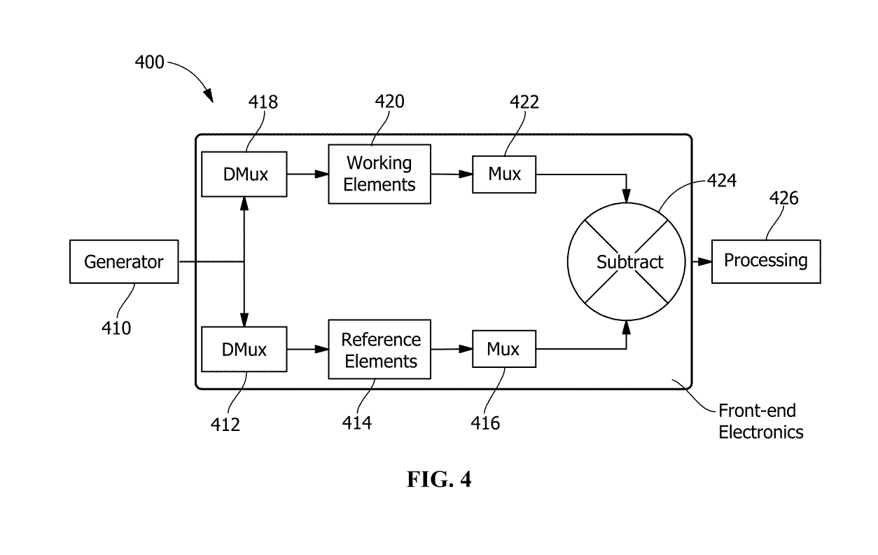

FIG. 4 is flowchart illustrating the components and functionality of front-end electronics 400 of an NDE system using the electromagnetic sensor array of the present invention. In the described embodiment, front-end electronics 400 consist of two main channels: working elements and reference elements. The working elements channel receives and transmits information from the AM component being evaluated while the reference element (coil positioned over good material) channel provides a signal that cancels any background detected from the material of the AM component and surrounding environment. The working elements and reference elements channels are connected in a bridge circuit, which provides improved sensitivity to changes detected in the properties of the materials being tested. Demultiplexer outputs and multiplexer inputs are buffered to improve circuit performance at high frequencies. In FIG. 4, front-end electronics 400 specifically include generator 410, which is connected to DMux 412, reference element 414, Mux 416, subtract junction 424, and processing device 426. Generator 410 is also connected to DMux 418, working element 420, Mux 422, subtract junction 424, and processing device 426.

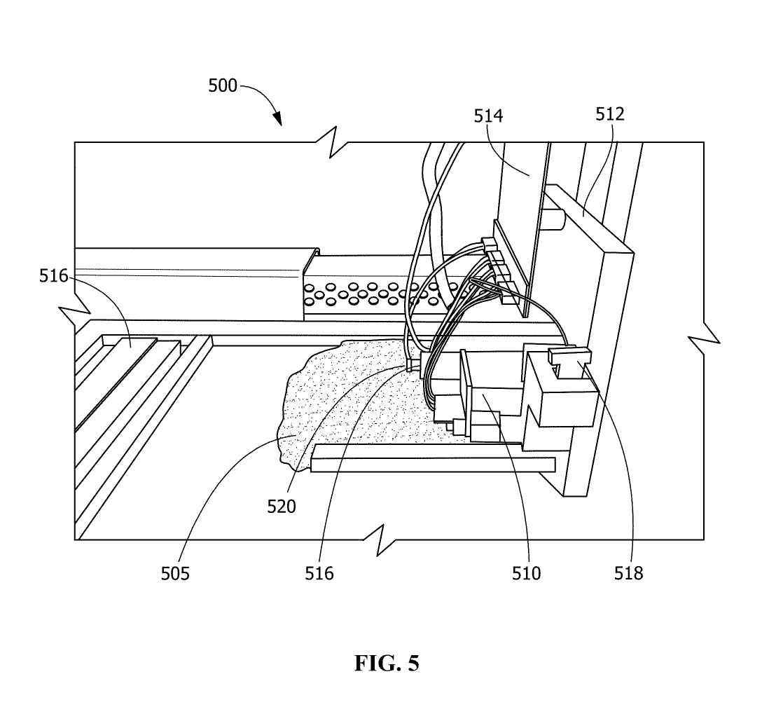

When using the systems, devices, and methods of the present invention to monitor and evaluate additive manufacturing processes, an examination is conducted after each metal layer is deposited. Scanning occurs at the surface at close proximity (about 75-200 microns distance, for example) without physical contact for reliable interrogation of the entire layer volume for surface and subsurface discontinuities, surface shape deviations, and other conditions of interest (e.g., change of microstructure, metallurgical phase, stresses, etc.). For specific additive manufacturing processes such as laser-powder bed fusion (L-PBF), the electromagnetic sensor array 100/200 is mounted on a re-coater blade or specially designed scanner arm or fixture in the L-PBF chamber (see FIG. 5). This configuration permits layer-by-layer examination and coverage of an area of interest with the minimum number of passes and precise positioning with respect to the additive manufacturing component top layer surface. The examination is conducted by following a laser or other fusion source when a single strip is deposited or after deposition of each layer to examine the entire surface and before application of powder for the next layer. Direct energy deposition layers and components can also be examined using the systems, devices, and methods of the present invention.

FIG. 5 is an illustration of exemplary eddy current-based NDE system 500 being used to evaluate a laser-powder bed fusion (L-PBF) process, which utilizes metal powder 505. Electromagnetic sensor array 510 is mounted on scanner arm 512. Front-end electronics 514 are mounted inside the L-PBF chamber in close proximity to electromagnetic sensor array 510, thereby providing an improved signal to noise ratio and the ability to work at high frequencies by eliminating the undesirable effects on signal integrity associated with using long connecting cables between instruments. Temperature is measured at three locations with multiple thermal sensors: balance plate thermal sensor 516; reference element thermal sensor 518; thermal sensor 520, which is mounted in front of electromagnetic sensor array 510. Thermal data is analyzed together with measurements taken from the examiner layer to allow for precise thermal compensation of each layer measurement.

Again with reference to FIG. 5, before each scan, electromagnetic sensor array 510 is positioned over the balance plate of the L-PBF system, where data is acquired from intact material similar to the material to be tested. This information is used to null or balance the measurement channels before each examination of newly deposited layer. This eliminates or significantly reduces any effects that temperature may have on system electronics (e.g., gain drifts). Electromagnetic sensor array 510 will generate signal when a discontinuity (e.g. crack, LOF between neighboring, or side-by-side, or top-to-bottom solidified tracks, porosity), shape irregularity (e.g., large area LOF), or defect condition (e.g., alloy composition deviation, stress) is detected. Eddy current-based NDE system 500 processes the discontinuity or condition signal and forwards a trigger signal to the L-PBF system or other additive manufacturing system. The additive manufacturing system then classifies the eddy current trigger signal and corrects the additive manufacturing process as necessary to eliminate the eddy current trigger signal (by ultimately rectifying the discontinuity or other condition of concern). The location and size of the eddy current indication is recorded and evaluated as being acceptable or unacceptable (i.e., rejected). If the indication is unacceptable, it is possible to reposition the system with electromagnetic sensor array 510, repair the location of concern, and reexamine the AM component or part. The described method can separate geometry and surface irregularity changes from material localized discontinuities and larger areas where material properties (e.g., stresses, phase and chemical composition, etc.) deviate from specifications if material property variations affect electrical conductivity and/or magnetic permeability. The methods of this invention can be used for both process monitoring and NDE during and after fabrication.

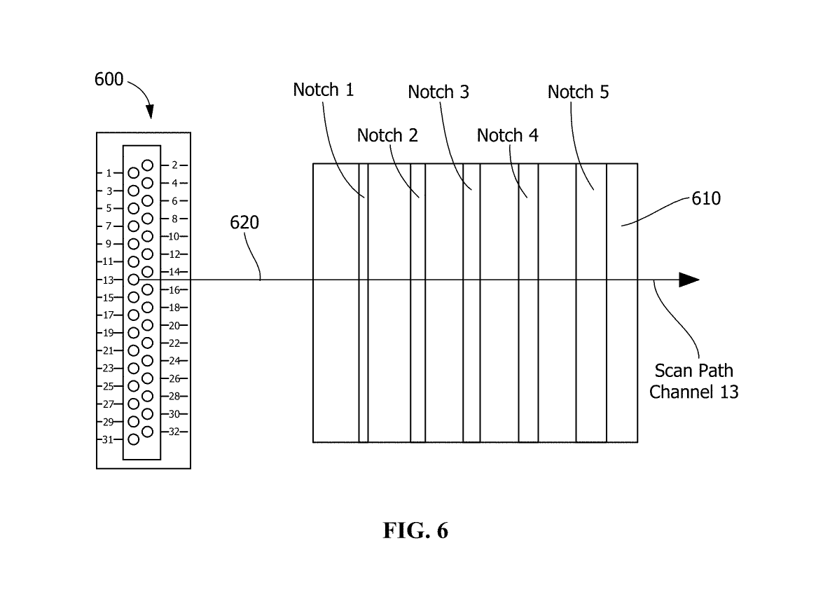

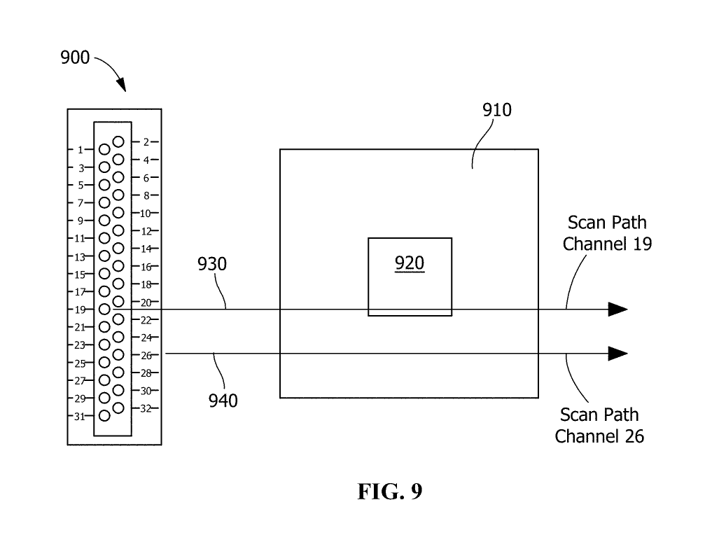

The functionality and accuracy of the present invention was tested by integrating electromagnetic sensor array 510 into a L-PBF test bed. As shown in FIG. 5, electromagnetic sensor array 510 was mounted on an XY-scanner arm to generate a C-scan view of an inspected area. A 20×20 mm test coupon was built from Inconel 625 alloy using additive manufacturing. As shown in FIGS. 6 and 9, two test features were embedded sequentially in the test coupon in the Z-direction (i.e., height): (a) a series of five notches having different widths; and (ii) a large area of LOF.

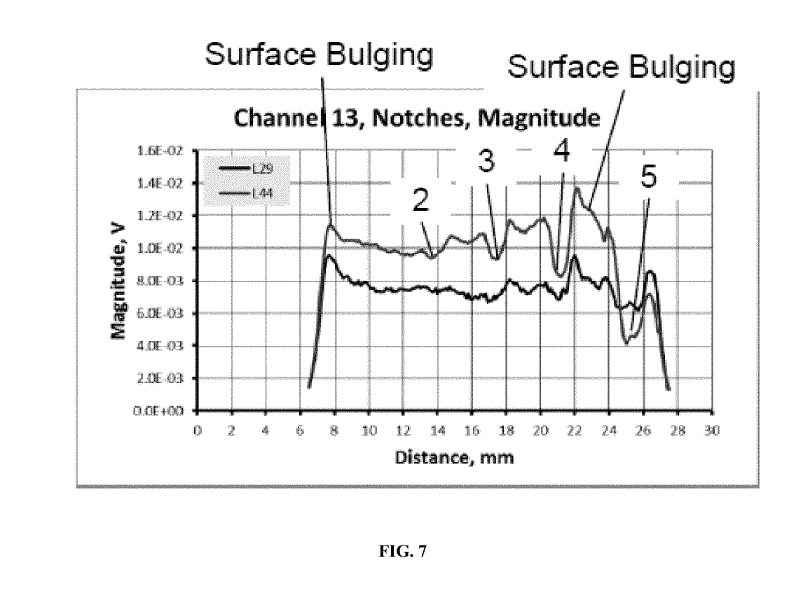

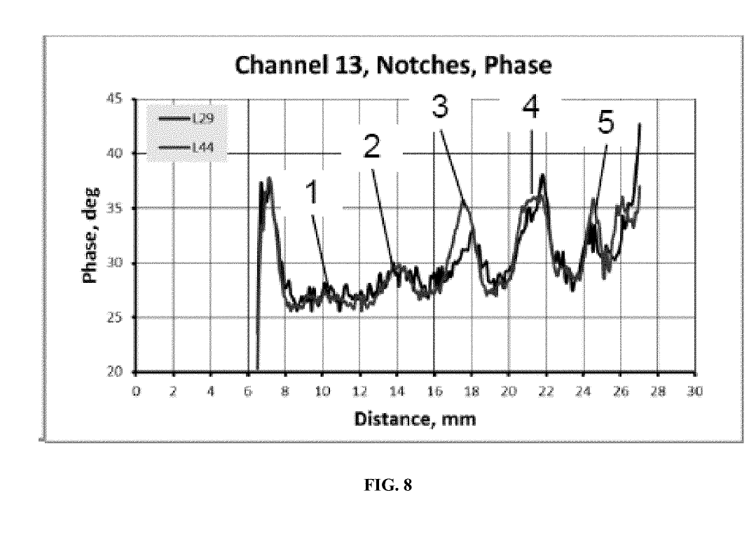

With reference to FIGS. 6-8, electromagnetic sensor array 600 was used to scan test coupon 610 along scan path 620 using channel 13 of electromagnetic sensor array 600. Notch design or desired width was 90 μm, 180 μm, 270 μm, 450 μm, and 900 μm for notches 1, 2, 3, 4, and 5 respectively. The notches were built with increasing height or depth from layer 26 (L26) to layer 45 (L45). Each layer added about 40 μm to notch depth. Data was acquired during the entire notch building process. Scanning data for one typical channel—channel 13 is shown in FIGS. 7-8 for L29 and L44. The shallow and narrow notches at L29 are more effectively detected on the phase plot (FIG. 8) The deeper notches are detected on both the magnitude and phase plots at L44 (FIG. 7-8). Notch signal magnitude and extent is also correlated to notch width and depth, which indicates the possibility for defect sizing. Previous studies indicated that the narrow notch (90 μm width) may have partially fused, thus explaining observed difficulties in detection on the magnitude plot. The surface of test coupon 610 started bulging around the wider notches due to heat transfer redistribution (see FIG. 7). The same affect was observed at edges of test coupon 610. After completing the notch build, 20 additional layers were deposited. The largest notch was also detectable as subsurface defect under several fused layers.

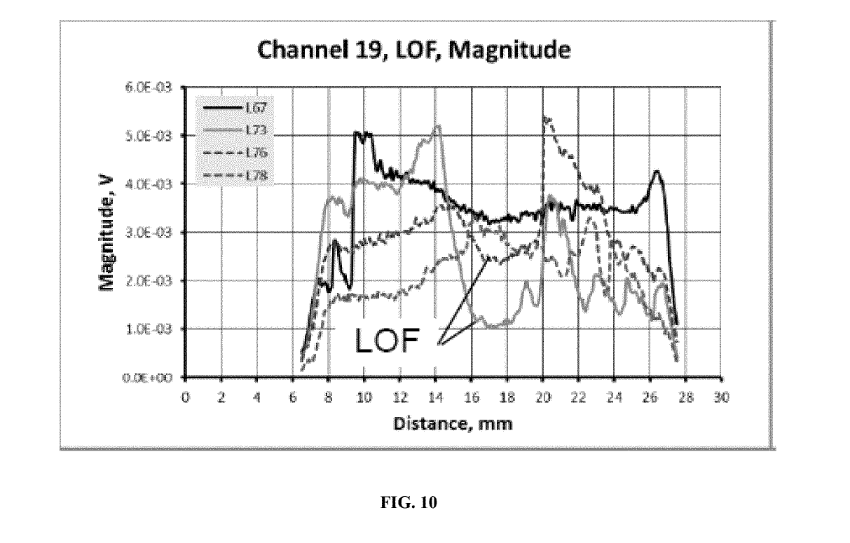

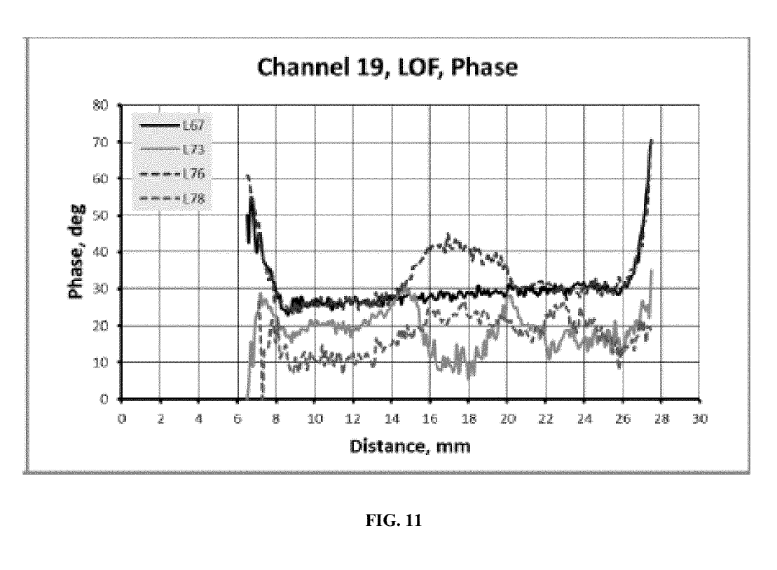

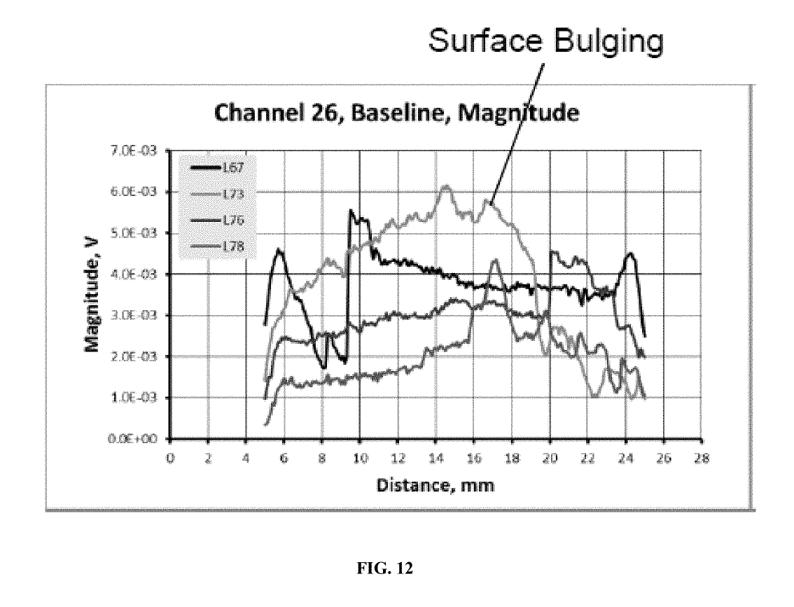

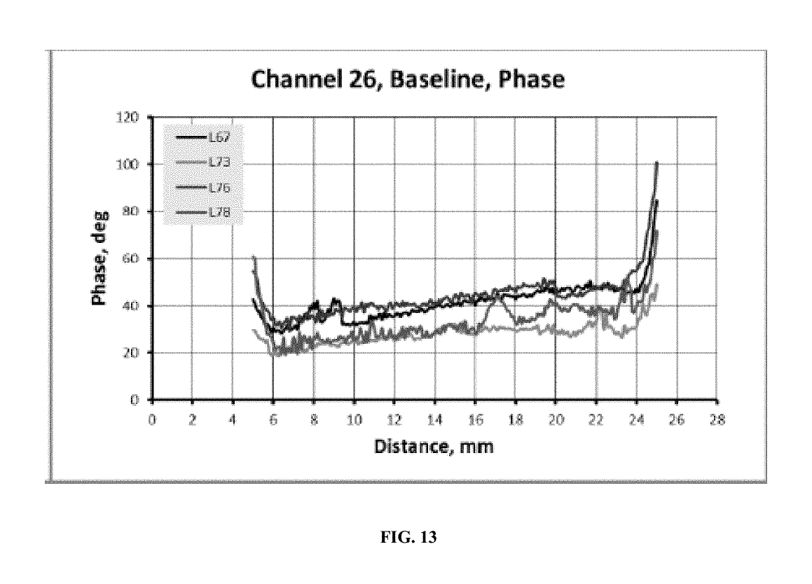

With reference to FIGS. 9-13, electromagnetic sensor array 900 was used to scan test coupon 910 along scan path 930 using channel 19 of electromagnetic sensor array 900 and along scan path 940 using channel 26 of electromagnetic sensor array 900. Large (5×5 mm) LOF area 920 was built from layer 67 (L67) to layer 75 (L75). The initial construction of test coupon 910 included building the lack of fusion area with a depth of 20 layers of material. However, the formation of a ridge or bulge near the LOF area edge caused re-coater to scrape the surface and the build process was stopped at L75. Surface area bulging was clearly detected well in advance of re-coater scraping (see FIG. 12). The scanning pattern and path of two array channels is shown in FIG. 9. The data shown in FIGS. 10-11, which was gathered from channel 19, clearly indicates the presence and growth of lack of fusion depth. The lack of fusion area was also detected as a subsurface gap at L76 under two or three fused layers of material. The phase plot of FIG. 11 allows clear separation of surface (negative phase change) from subsurface (positive phase change) defects. The plots from channel 26 shown in FIGS. 12-13, away from the LOF area clearly indicate the surface bulging effect (see the magnitude plot of FIG. 12) during lac of fusion build and shortly thereafter.

In summary, this invention includes the following features and advantageous. First, an electromagnetic sensor array is provided that includes a plurality of coils embedded in a field-concentrating media or matrix that greatly increases the intensity of the electromagnetic field near the coils resulting in improved resolution and sensitivity to discontinuities and conditions in AM components or parts being evaluated. Second, two identical system channels (working and reference) in terms of electronic components that provide efficient cancellation of any background signal originating from the material being evaluated and surrounding environment. This aspect permits the system to amplify and process only signals which represent the difference between “good” or reference material and the material of the AM component or part being evaluated. Third, the system corrects measurements taken from an AM component or part being evaluated by gathering and processing thermal data gathered from three separate locations within an active additive manufacturing system. Fourth, the balance plate within the additive manufacturing device is used to provide a reference surface away from the AM component or part being evaluated to compensate for temperature effects and drifts during additive manufacturing builds having a long duration. Fifth, using both signal magnitude and signal phase data and calculations to improve detection capabilities of surface and subsurface defects and conditions.

While the present invention has been illustrated by the description of exemplary embodiments thereof, and while the embodiments have been described in certain detail, there is no intention to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the general inventive concept.

What is claimed:

1) A system for non-destructively evaluating components fabricated by additive manufacturing systems and processes, comprising:
(a) a sensor array, wherein the sensor array is embedded within an electromagnetic field concentrating material or matrix, and wherein the sensor array includes:
(i) a plurality of individual elements arranged in a predetermined pattern for allowing substantially uniform coverage of an area of an electrically conductive component to be evaluated;
(ii) wherein each element in the plurality of elements further includes at least one coil that acts as an exciter coil for generating an alternating electromagnetic field when activated, or a receiver coil for measuring a change in impedance of the at least one coil, or as both an exciter coil and a receiver coil;
(iii) wherein the alternating electromagnetic field induces eddy currents in the component to be evaluated; and
(iv) wherein the individual elements in the sensor array are excited in a predetermined sequence during a single pass of the sensor array over the area to be evaluated.

2) The system of claim 1, wherein the sensor array includes Hall-effect sensors or giant magnetoresistive (GMR) sensors.

3) The system of claim 1, wherein the predetermined pattern of the individual elements in the sensor array includes two substantially parallel rows of elements arranged in a staggered pattern relative to one another.

4) The system of claim 1, wherein the sensor array is positioned at a distance of about 75-200 microns from the surface being scanned.

5) The system of claim 1, wherein the system is operative to detect cracks, LOF between neighboring, side-by-side, or top-to-bottom solidified tracks, porosity defects, shape irregularities, alloy composition deviations, and stressed areas of the component being evaluated.

6) The system of claim 1; wherein the system is adapted for use with laser-powder bed fusion additive manufacturing processes.

7) A system for non-destructively evaluating components fabricated by additive manufacturing systems and processes, comprising:
(a) a sensor array, wherein the sensor array is embedded within an electromagnetic field concentrating material or matrix, and wherein the sensor array includes:
(i) a plurality of individual elements arranged in a predetermined pattern for allowing substantially uniform coverage of an area of an electrically conductive component to be evaluated;
(ii) wherein each element in the plurality of elements further includes at least one coil that acts as an exciter coil for generating an alternating electromagnetic field when activated, or a receiver coil for measuring a change in impedance of the at least one coil, or as both an exciter coil and a receiver coil;
(iii) wherein the alternating electromagnetic field induces eddy currents in the component to be evaluated; and
(iv) wherein the individual elements in the sensor array are excited in a predetermined sequence during a single pass of the sensor array over the area to be evaluated; and
(b) a processor for receiving and characterizing data gathered by the sensor array, wherein the processor is configured to include a working channel and a reference channel, and wherein the working channel and reference channel cooperate to cancel any background signal originating from the component being evaluated and the surrounding environment.

8) The system of claim 7, wherein the predetermined pattern of the individual elements in the sensor array includes two substantially parallel rows of elements arranged in a staggered pattern relative to one another.

9) The system of claim 7, wherein the sensor array is positioned at a distance of about 75-200 microns from the surface being scanned.

10) The system of claim 7, wherein the system is operative to detect cracks, LOF between neighboring, side-by-side, or top-to-bottom solidified tracks, porosity defects, shape irregularities, alloy composition deviations, and stressed areas of the component being evaluated.

11) The system of claim 7, wherein the system is adapted for use with laser-powder bed fusion additive manufacturing processes.

12) The system of claim 7, further including multiple thermal sensors that gather temperature information from within an additive manufacturing device for correcting measurements taken from a component being evaluated by the sensor array.

13) The system of claim 7, further including a reference surface positioned within an additive manufacturing device away from the component being evaluated by the sensor array for compensating for temperature effects and drifts occurring during additive manufacturing builds of long duration.

14) The system of claim 7, wherein the system uses both signal magnitude and signal phase calculations to enhance the system's detection of surface and subsurface defects and conditions.

15) A system for non-destructively evaluating components fabricated by additive manufacturing systems and processes, comprising:
(a) a sensor array, wherein the sensor array is embedded within an electromagnetic field concentrating material or matrix, and wherein the sensor array includes:
(i) a plurality of individual elements arranged in a staggered pattern for allowing substantially uniform coverage of an area of an electrically conductive component to be evaluated;
(ii) wherein each element in the plurality of elements further includes at least one coil that acts as an exciter coil for generating an alternating electromagnetic field when activated, or a receiver coil for measuring a change in impedance of the at least one coil, or as both an exciter coil and a receiver coil;
(iii) wherein the alternating electromagnetic field induces eddy currents in the component to be evaluated; and
(iv) wherein the individual elements in the sensor array are excited in a predetermined sequence during a single pass of the sensor array over the area to be evaluated;
(b) a processor for receiving and characterizing data gathered by the sensor array, wherein the processor is configured to include a working channel and a reference channel, and wherein the working channel and reference channel cooperate to cancel any background signal originating from the component being evaluated and the surrounding environment; and
(c) a plurality of thermal sensors for gathering temperature information during an additive manufacturing process wherein the sensor array is evaluating a component being fabricated.

16) The system of claim 15, wherein the sensor array is positioned at a distance of about 75-200 microns from the surface being scanned.

17) The system of claim 15, wherein the system is operative to detect cracks, LOF between neighboring, or side-by-side, or top-to-bottom solidified tracks, porosity defects, shape irregularities, alloy composition deviations, and stressed areas of the component being evaluated.

18) The system of claim 15, wherein the system is adapted for use with laser-powder bed fusion additive manufacturing processes.

19) The system of claim 15, further including a reference surface positioned within an additive manufacturing device away from the component being evaluated by the sensor array for compensating for temperature effects and drifts occurring during additive manufacturing builds of long duration.

20) The system of claim 15, wherein the system uses both signal magnitude and signal phase calculations to enhance the system's detection of surface and subsurface defects and conditions.
